(19) United States
(12) Patent Application Publication
(10) Pub. No.: US 2006/0209680 A1
(43) Pub. Date: Sep. 21, 2006

(54) Network link backup system

(76) Inventor: Chun-Liang Lee, Taipei (TW)

Correspondence Address: RABIN & BERDO, P.C., Suite 500, 1101 14 Street N.W., Washington, DC, 20005, US

(21) Appl. No.: 11/080,507

(22) Filed: Mar. 16, 2005

(51) Int. Cl. H04L 12/26

(52) U.S. Cl. 370/217

(57) ABSTRACT

A network link backup system includes at least one network port to be selectively connected to a server system for linking the server system to a network; a baseboard management control unit to generate a selection switch signal according to a switch command entered by a manager; and a selection switch unit to switch the linking route between the server system and the Internet according to the selection switch signal. When the network link of the server system malfunctions, the manager can switch to a backup link to maintain network connectivity of the server system, thereby enhancing the reliability and stability of the server system.

### FIELD OF THE INVENTION

The invention relates to a network link backup system, and particularly to a network link backup system for servers.

### BACKGROUND OF THE INVENTION

With the arrival of the information age, many enterprises and companies use server systems to manage and store vital data. In recent years a management method that adopts an intelligent platform management interface (IPMI) has been used in these server systems. The IPMI provides an interface across platforms to monitor server conditions (such as voltage, system temperature, rotation speed of cooling fans and the like). Hence the management software provided by different vendors can be used in different firmware and hardware platforms, and the cost of the server system can be reduced.

In general, a baseboard management controller (BMC) is provided in the server system to receive data packets from an IPMI through a network port to monitor and manage the server system. Although the server system has many network ports, the data packets of the IPMI are mainly transmitted through a preset network link. If a network port on the network link breaks down or malfunctions, the server system cannot perform monitoring and managing operations. Normal link function can only be resumed after repairs of the network link equipment of the server system are finished.

Therefore to provide a network link backup system to supply a backup network link when a preset network link of the server system malfunctions, maintain the linking capability of the server system, and enhance the reliability and stability of the server system is one issue remaining to be resolved in the industry.

### SUMMARY OF THE INVENTION

In view of the aforesaid disadvantages of the conventional techniques, the primary object of the invention is to provide a network link backup system that can maintain network connectivity by switching to a backup network link when a preset network link malfunctions, thereby enhancing the reliability and stability of a server system.

In order to achieve the foregoing object, the network link backup system according to the invention includes at least one network port, a baseboard management controller and a selection switch unit.

The network port is selectively connected to a server system for linking the server system to a network. The network port is an Ethernet transmission port.

The baseboard management controller is connected to the network port to generate a selection switch signal according to a switch command input by a manager. The baseboard management controller is connected to the network port through a system management bus (SM bus) or a peripheral controller interface (PCI).

The selection switch unit is located between the network port and the baseboard management controller to switch the network port connecting to the server system according to the selection switch signal to enable the server system to be connected to the network through another network port. The selection switch unit may accomplish the required function through a multiplexer.

To achieve the foregoing object, the invention further provides a network link switch method, which includes the following steps:

Detect whether the network link is abnormal: a manager confirms network link conditions of the server system; if the network link is abnormal, the manager selects a control method to switch the network link and issues a switch command; next, generate a selection switch signal according to the switch command to switch to a corresponding network link.

The control method may be selected through a serial communication port or an intelligent platform management bus (IPMB) linking to the baseboard management controller to issue the switch command, or through the basic input output system (BIOS) of the server system to issue the switch command to switch the network link.

By means of such a network link backup system, when the network link of the server system malfunctions, it can be switched to the backup network link to maintain linking operation for the server system, thereby enhancing the reliability and stability of the server system.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of the invention;

FIG. 2 is a process flow chart of the invention; and

FIG. 3 is a system block diagram of the invention for linking the selection switch unit to the baseboard management controller.

### DESCRIPTION OF THE PREFERRED EMBODIMENTS

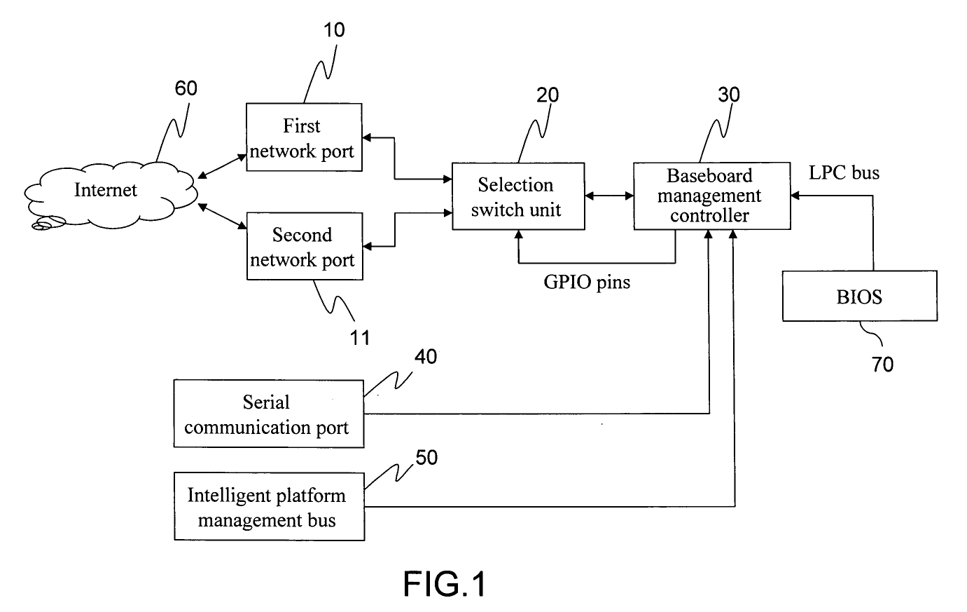

Refer to FIG. 1 for the system block diagram of the invention to connect a server system to a network. It includes a first network port 10, a second network port 11, a selection switch unit 20 and a baseboard management controller 30.

The first network port 10 provides a connection interface for linking the server system to the Internet 60, and is a preset main connection interface of the server system for linking to the Internet 60. The first network port 10 is an Ethernet transmission port.

The second network port 11 is a connection interface network port for linking the server system to the Internet 60, and is an Ethernet transmission port.

The selection switch unit 20 is located between the first network port 10, the second network port 11 and the baseboard management controller 30. Based on the selection switch signal generated by the baseboard management controller 30, the selection switch unit switches to the first network port 10 or the second network port 11 to connect to the server system so that the server system can be connected to the Internet 60. The selection switch unit 20 may accomplish the required function through a multiplexer. In addition, the selection switch unit 20 is connected to a preset network link that is also the network link of the first network port 10.

The baseboard management controller 30 is the nuclear module of the management control system of the server system (such as the IPMI) to manage the server system through various connection interfaces (such as the serial communication port, intelligent platform bus and network port, or the like). It includes power supply management, system restore, system condition recording and the like. Through the first network port 10 or the serial communication port 40, the system condition information is sent to a manager to manage the server system.

The baseboard management controller 30 can further generate a selection switch signal according to a switch command issued by the manager. Through general purpose input output (GPIO) pins, the selection switch signal is output to the selection switch unit 20 to control the operation of the selection switch unit 20. The baseboard management controller 30 is connected to the first network port 10 and the second network port 11 through a System Management Bus (SM Bus) or a Peripheral Controller Interface (PCI) to transmit signals to the server system.

The serial communication port 40 aims to provide a channel for transmitting IPMI signals or packets so that the manager can manage the server system through a modem from a remote site. Through this interface or a system interface (such as the BIOS 70) and a low pin count bus (LPC bus), the manager can also issue a switch command to the baseboard management controller 30 to switch the network link.

An intelligent platform management bus (IPMB) 50 also is provided to serve as a connection interface between the baseboard management controller 30 and an external system detector (not shown in the drawings) to retrieve a system detection value and communicate with an external control unit (not shown in the drawings). The manager can also issue the switch command through this interface to the baseboard management controller 30 to switch the network link.

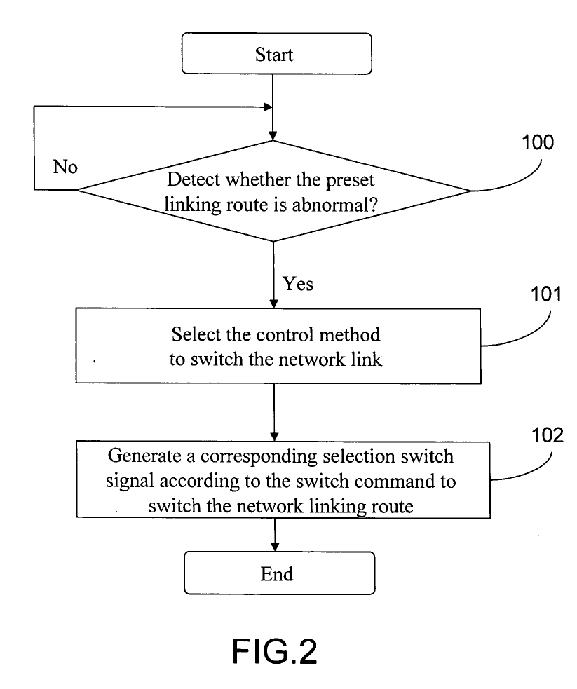

Refer to FIG. 2 for the process flow of the invention. First, detect whether the preset network link is abnormal (step 100): a manager confirms the network link condition of the server system; if the network link is confirmed to be abnormal and the link cannot be established, prepare to switch the network link; next, the manager selects the control method for switching the network link (step 101), such as by issuing a switch command through the serial communication port 40 or the IPMB 50 that is connected to the baseboard management controller 30.

Another control method is to issue the switch command through the BIOS 70 of the server system and the LPC bus to the baseboard management controller 30 (such as modifying the network protocol IP set value). The baseboard management controller generates a corresponding selection switch signal according to the switch command that is output to the selection switch unit through the GPIO pins to switch the network link (step 102).

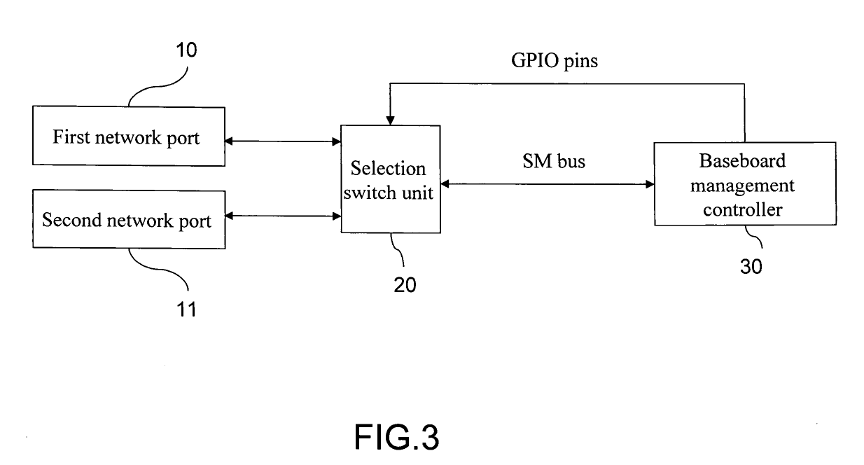

Refer to FIG. 3 for the system block diagram of the invention for linking the selection switch unit to the baseboard management controller. First, one end of the selection switch unit 20 is connected to the first network port 10 and the second network port 11 through the SM Bus or PCI to link to the Internet and transmit signals or data to the server system. Another end of the selection switch unit 20 is connected to the baseboard management controller 30 through the GPIO pins and SM bus. The selection switch unit 20 is a multiplexer that consists of MOS transistor switches or IC route switches. When the selection switch unit 20 receives the selection switch signal from the baseboard management controller 30 through the GPIO pins, a route switch operation is executed to select the first network port 10 or the second network port 11 to transmit data.

By means of the network link backup system set forth above, when the network link of a server system malfunctions, a switching operation of the network link for the server system may be performed onsite or from a remote location to maintain network connectivity of the server system, thereby enhancing the reliability and stability of the server system.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A network link backup system, comprising:
at least one network port to be selectively connected to a server system for linking the server system to a network;
a baseboard management controller which is connected to the network port and generates a selection switch signal according to a switch command; and
a selection switch unit located between the network port and the baseboard management controller to switch the network port linking to the server system according to the selection switch signal so that the server system is connected to the network through another network port.

2. The network link backup system of claim 1, wherein the network port is an Ethernet transmission port.

3. The network link backup system of claim 1, wherein the baseboard management controller is connected to the network port through a system management bus.

4. The network link backup system of claim 1, wherein the baseboard management controller is connected to the network port through a peripheral controller interface.

5. The network link backup system of claim 1, wherein the selection switch unit is a multiplexer.

6. The network link backup system of claim 1, wherein the baseboard management controller outputs the selection switch signal to the selection switch unit through general purpose input output pins.

7. The network link backup system of claim 1, wherein the baseboard management controller receives the switch command through a serial communication port to generate the selection switch signal.

8. The network link backup system of claim 1, wherein the baseboard management controller receives the switch command through an intelligent platform management bus to generate the selection switch signal.

9. The network link backup system of claim 1, wherein the baseboard management controller receives the switch command through a basic input output system to generate the selection switch signal.
